(19) United States
(12) Patent Application Publication
(10) Pub. No.: US 2006/0209339 A1
(43) Pub. Date: Sep. 21, 2006

(54) Apparatus and method for fine tuning a print engine on a line start pixel

(76) Inventors: Didier Le Maitre, Antony (FR); Philippe Gautier, Fontenay aux Roses (FR)

Correspondence Address: GLENN PATENT GROUP, 3475 EDISON WAY, SUITE L, MENLO PARK, CA, 94025, US

(21) Appl. No.: 11/373,790

(22) Filed: Mar. 10, 2006

Related U.S. Application Data
(60) Provisional application No. 60/662,385, filed on Mar. 17, 2005.

(51) Int. Cl. G06F 3/12

(52) U.S. Cl. 358/1.15; 358/1.8

(57) ABSTRACT

The need for horizontal alignment of a laser printer print head is a well-known challenge. It is necessary to ensure that the print head starts printing a next line in alignment with the immediately previous line to guarantee an eye-pleasing printed image. The invention provided disclosed a method and apparatus for the purpose of horizontal alignment by using a higher frequency than the horizontal synchronization frequency to adjust the print head position to 1/n^{th} accuracy. This is further applicable for the purpose of using a single controller that is designed to drive multiple types of print heads, each having its own printing and alignment characteristics.

### CROSS-REFERENCE TO RELATED APPLICATIONS

This invention claims priority of U.S. provisional patent application 60/662,385, filed on Mar. 10, 2005, the entirety of which is incorporated herein by this reference thereto.

### BACKGROUND OF THE INVENTION

1. Technical Field

The invention relates generally to the control of printer heads in LASER printers. More particularly, the invention relates to the fine alignment of a start pixel in a vertical line.

2. Discussion of the Prior Art

When printing using, for example, a laser printer, a vertical synchronization (VS) signal is generated by the print engine depicting the movement of the paper inside the engine in vertical direction of the page. A horizontal synchronization (HS) signal is typically also generated by the print engine to start the printing at a start position for each line. Commonly, the HS signal is generated by means of a light detector on the side of the drum which signals that the laser beam is starting a new scan. Because HS is generated by the engine, and generally without any clock signal, there is an asynchronous operation between the print engine and the data supplied by the controller. Therefore, inaccuracies in the generation of the HS signal and the asynchronous operation due to of the system clock, there may be a difference at the beginning point of printing between one start-line point and a subsequent start-line point when printing takes place. These inaccuracies result in a lower quality image, which is particularly bad when high-resolution printers are involved. It is problematic when the printer head is capable of printing at high-speeds and these inaccuracies must be corrected at such high speeds. It is further problematic when it is necessary to align print heads initially, or when using a single type of controller to drive a variety of print heads.

There are several prior are techniques that attempt resolve the misalignment that occurs in such cases. The general approach attempts to smoothen the printed image and therefore overcome the misalignment that occurs from the misplacement of the start pixel at the beginning of the vertical line. In one such application, pixels are even replaced with sub-pixels, where a plurality of sub-pixels comprise a single pixel. By manipulating the number of sub-pixels it is possible to align the vertical printout better. Major deficiencies of prior art solutions include, inter alia the inability to support a plurality of printer head types easily using a single type controller. A further difficulty arises when high speed is required for the processing of the smoothing algorithms.

Due to the deficiencies of prior art solutions there is therefore a need for a system and method that would allow for a fine alignment of the start pixel in a vertical line. It would be further advantageous if such solution would not require manipulation of the pixel itself, and it would be further advantageous if such implementation could be used at the high printing speeds of modern print heads.

### SUMMARY OF THE INVENTION

The need for horizontal alignment of a laser printer print head is a well-known challenge. It is necessary to ensure that the print head starts printing a next line in alignment with the immediately previous line to guarantee an eye-pleasing printed image. The invention provided disclosed a method and apparatus for the purpose of horizontal alignment by using a higher frequency than the horizontal synchronization frequency to adjust the print head position to 1/n^{th} accuracy. This is further applicable for the purpose of using a controller that is designed to drive multiple types of print heads, each having its own printing and alignment characteristics.

### BRIEF DESCRIPTION OF THE DRAWINGS

FIG. 1 is a schematic diagram showing misalignment of a start pixel (prior art);

FIG. 2 is a timing diagram showing print head signals timing diagram (prior art);

FIG. 3 is a block diagram showing a circuit for generating N times a video signal

FIG. 4 is a block diagram showing a circuit for the adjustment of horizontal synchronization;

FIG. 5 is a timing diagram showing a synchronized horizontal signal in accordance with the disclosed invention; and

FIG. 6 is a schematic diagram showing of a start pixel aligned in accordance with the disclosed invention

### DETAILED DESCRIPTION OF THE INVENTION

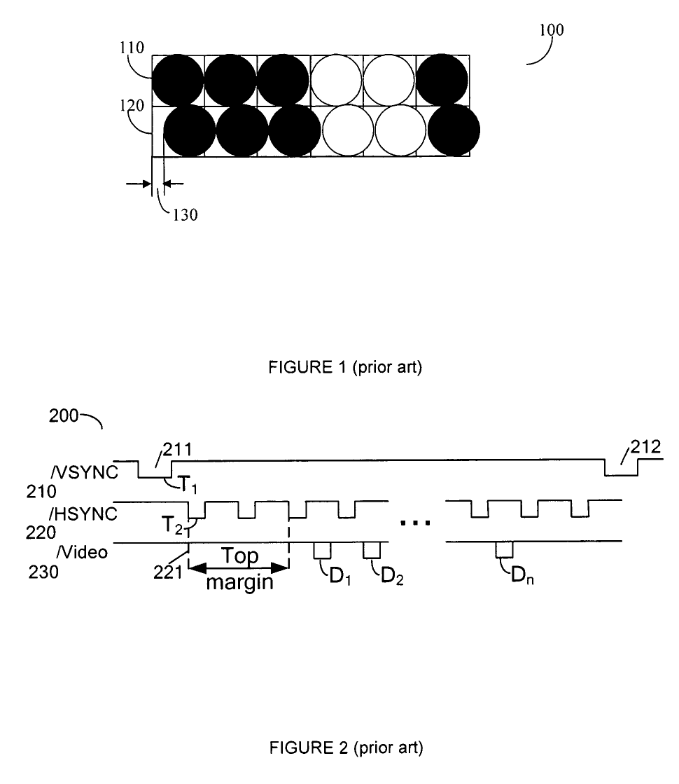

The deficiencies of prior art require that there be provided a method and apparatus that can adjust the horizontal synchronization of a printer head, such that a start pixel of a horizontal line, for example line 120 in FIG. 1, printed subsequent to line 110, is aligned with the start pixel of line 110. However, as noted above, inaccuracies in the creation of the control signals typically causes a misalignment, such as misalignment 130, which reduces the quality of the printed material.

An exemplary and non-limiting timing diagram 200 is shown in FIG. 2 depicting the various signals that operate a typical printer head. The signal /VSYNC 210 is an active low signal, active at T₁ zones 211 and 212. Typically T₁ has a minimum value of 500 nS. In the time between 211 and 212, all the horizontal lines of the page being printed, for example on a letter size page, must be completed. Signal /HSYNC 220 begins the printing process of each horizontal line, based on data provided by the /Video signal 230, that provides the actual data for the printing. It would be beneficial to control the beginning 221 of /HSYNC 220 signal periods T₂, such that the start pixel printed in a line 120 is aligned with the start pixel printed in the previous line 110. Typically T₂ has a minimum value of 500 nS.

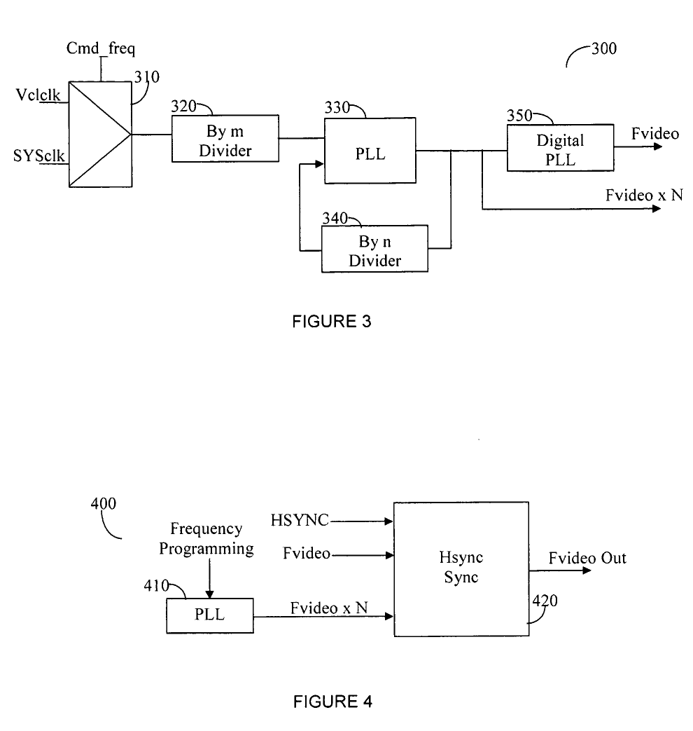

FIG. 3 is a block schematic diagram showing an exemplary circuit 300 for generating N times the video signal. It should be noted that it is unknown when exactly the /HSYNC signal 220 goes active and, therefore, it is necessary to synchronize video data 230 and /HSYNC 220 signals. For this purpose, circuit 300 generates from the output of digital PLL 350 an F Video sync signal that has the same frequency as that of the video frequency, but that is synchronized to /HSYNC 220. To obtain a high precision and overcome the limitations of prior art solutions, a 1/N distance of a pixel movement is enabled by using a frequency N times higher than F video. This allows for the precise detection of transitions in /HSYNC 220.

The circuit comprises a multiplexer 310 that allows the selection from a plurality of clock frequencies, which may be desirable when operating in higher resolutions. The high frequency may be divided, for example by ‘m’, using a divider 320. The output is fed into a phase locked loop (PLL) 330 that generates an F Video×N signal. The value of ‘N’ may be selectable from a plurality of values. A divider by N 340 is used as a feedback to PLL 330. A digital PLL 350 is used to generate the F video signal, resulting in both the frequencies needed. These signals drive a circuit shown in FIG. 4, that produces the F video out signal, i.e., a signal synchronized and aligned as required.

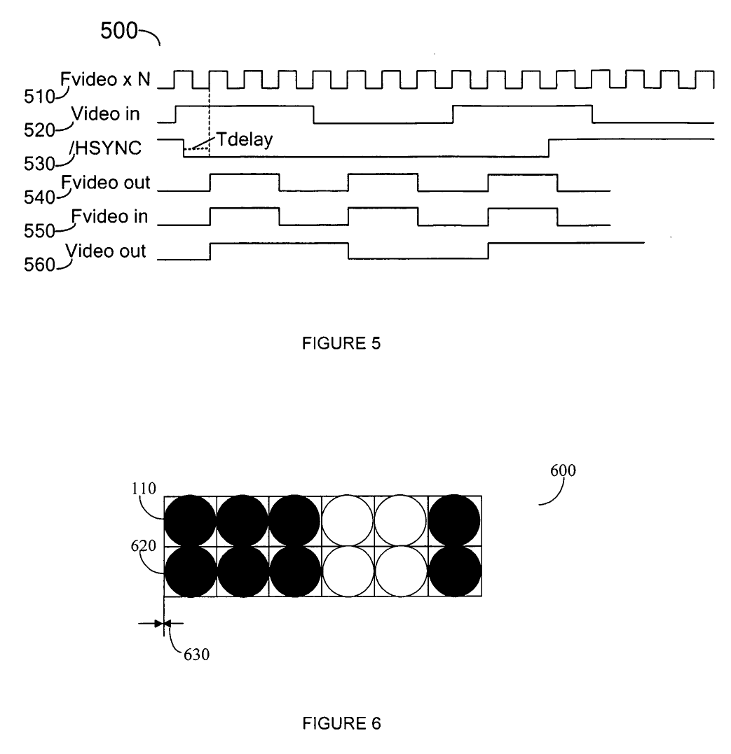

FIG. 5 provides an exemplary and non-limiting timing diagram 500 of the synchronized horizontal signal in accordance with the disclosed invention. By using the high frequency of F video×N 510 it is possible to adjust a delay from /HSYNC 530 signal, such that the video out signal 560 is delayed by a desired time from the transition of /HSYNC 530. In FIG. 5, a delay to the immediately first transition of F video×N 510 is shown, however it could be programmed to synchronize on the second transition and so forth. In one embodiment of the invention, it is necessary to limit this frequency to avoid problems associated with the use of high frequencies in the circuit. In such a case, precision depends on the number of dots-per-inch (dpi) precision of printing. For example if N=8 then in 2400 dpi there is a one dot precision; in 1200 dpi: ½ dot precision; in 600 dpi ¼ dot precision; and, in 300 dpi: ⅛ dot precision.

FIG. 6 shows an exemplary and non-limiting enlargement 600 of a start pixel aligned in accordance with the disclosed invention. As can be seen, the start pixel in line 620 is aligned with the start pixel of line 110 causing the misalignment 630 to be reduced to a minimal value, depending on the precision chosen.

The method shown herein may be implemented in hardware, software, firmware, or any combination thereof. Furthermore, it may be embodied in a computer software product that contains a plurality of executable instructions designed to be executed for the purpose of performing the methods disclosed herein. A computer software product may be embodied in a hard disk, semiconductor memory, magnetic disk, and the like.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. Apparatus for synchronizing data supplied by a printer controller to a printer head comprising:
a circuit for generating a synchronizing video signal having a frequency that is N times higher than an input video signal; and
a circuit for using said synchronizing video signal to effect fine synchronization between a horizontal synchronization signal and an output video signal that is sent to said printer head.

2. The apparatus of claim 1, wherein the value of N establishes a degree of precision.

3. The apparatus of claim 1, wherein said fine synchronization takes place at a step up of said printer head.

4. The apparatus of claim 1, wherein said fine synchronization circuit selects a required delay from said horizontal synchronization signal.

5. The apparatus of claim 1, wherein said printer head prints a start pixel of a horizontal print line that is essentially aligned with a start pixel of a previous horizontal print line.

6. The of claim 5, wherein said previous horizontal line is a horizontal line immediately previous to a horizontal print line.

7. A printer comprising the control circuit of claim 1.

8. The printer of claim 7, wherein said printer comprises a laser printer.

9. The apparatus of claim 1, wherein said generating circuit comprises:
a multiplexer for directing to its output any of a video clock and a system clock based on a control signal;
a first divider coupled to an output of said multiplexer for dividing said output signal of said multiplexer by a first predefined value;
a phase-locked-loop (PLL) coupled to an output of said first divider for generating a video signal that is N times the frequency of said first divider;
a second divider coupled to an output of said PLL and further to an input of said PLL for dividing the video signal by a second predefined value; and
a digital PLL coupled to said PLL for generating a video signal having a frequency which is equal to the input frequency divided by N.

10. The apparatus of claim 9, wherein the output signal of said PLL and the output signal of said digital PLL are coupled to a circuit for synchronizing said horizontal synchronization signal to said video signal.

11. A method for synchronizing data provided by a printer controller, comprising the steps of:
generating a synchronizing video signal having a frequency N times higher than an input video signal;
using said synchronizing video signal to perform a fine synchronization of a horizontal synchronization signal and a video signal sent to said printer head;
wherein a start pixel of a first horizontal line is aligned with a start pixel of a second horizontal line

12. The method of claim 10, said fine synchronization step further comprising the step of:
selecting a required delay from said horizontal synchronization signal.

13. A computer software product embodying a plurality of executable instructions that when executed perform the method of claim 11.

14. A printer control for controlling a print head operative in accordance with the method of claim 11.

15. A printer comprising a printer control of claim 14.

16. The printer of claim 15, wherein said printer comprises a laser printer.
